(19) United States
(12) Patent Application Publication
(10) Pub. No.: US 2012/0005250 A1
(43) Pub. Date: Jan. 5, 2012

(54) Systems and Methods for Recording Communication Sessions

(75) Inventor: Tolga Asveren, Bordentown, NJ (US)

(73) Assignee: Sonus Networks, Inc., Westford, MA (US)

(21) Appl. No.: 12/829,710

(22) Filed: Jul. 2, 2010

(51) Int. Cl. G06F 15/16

(52) U.S. Cl. 709/201

(57) ABSTRACT

A system for recording a communication session is disclosed. The system includes an edge device configured to receive a message that includes information about the communication session, determine whether to record the communication session based on at least one criterion, and mark the message to indicate that the communication session should be recorded if the at least one criterion is satisfied. The system also includes a signaling entity configured to receive the message from the edge device and, if the at least one criterion is satisfied, direct the message to a recorder configured to record the communication session.

### FIELD OF THE INVENTION

The invention relates generally to recording media streams associated with communication sessions in a network environment, and more particularly, to using a network component (e.g., an edge device) to classify communication sessions for recording purposes.

### BACKGROUND OF THE INVENTION

Session recording is a requirement in IP telephony communications environment such as call centers and financial trading. Calls can be recorded for regulatory, compliance, and consumer protection purposes.

A traditional approach to recording media sessions is the passive sniffing technique. Under this approach, recording devices detect media to be recorded directly from the network by analyzing pass-by communication packets on various network entities. Passive sniffling requires gateways and other network components to copy all network traffic to the recording system. Drawbacks of this approach include limited scalability, increased administration and heightened security risks.

### SUMMARY OF THE INVENTION

The invention, in various embodiments, features a system for recording communication sessions in a network environment. The system uses a network component, such as an edge device, to classify communication sessions for recording. The network component can provide an intelligent approach to managing and recording media communications. In an exemplary recording system, an edge device is configured to determine whether a communication session should be recorded by comparing information about the communication session with one or more recording conditions, policies and/or criteria.

The edge device can be configured to mark information associated with a communication session to indicate the need to record the session. The edge device can have access to more information about communication sessions than other network components, and can make more informed recording determinations as a result. For example, allowing the edge device, as opposed to a recorder, to make recording determinations is advantageous because a recorder does not know certain information, such as the ingress trunk group information about a communication session and, therefore, cannot determine whether a session needs to be recorded on that particular basis.

An edge device can transmit information about communication sessions to a signaling entity for further processing, regardless of whether the information includes recording indications. The signaling entity, however, only transmits to a recorder information about those communication sessions marked for recording. Hence, a recorder only records a communication session upon receiving information about the session from the signaling entity. The signaling entity need not forward to the recorder information about communication sessions that does not include a recording indication. Selective information forwarding can reduce costs and resource overhead associated with forwarding information about all calls, including the ones that are not to be recorded, from the signaling entity to the recorder.

In one aspect, the invention features a method for recording a communication session. The method includes receiving a message that includes information about the communication session, and determining whether to record the communication session based on at least one criterion. In addition, the method includes marking the message to indicate that the communication session should be recorded if the at least one criterion is satisfied, and transmitting the message to a signaling entity configured to direct the message to a recorder if the at least one criterion is satisfied.

In another aspect, the invention features a system for recording a communication session. The system includes an edge device configured to receive a message that includes information about the communication session, determine whether to record the communication session based on at least one criterion, and mark the message to indicate that the communication session should be recorded if the at least one criterion is satisfied. The system also includes a signaling entity configured to receive the message from the edge device and, if the at least one criterion is satisfied, direct the message to a recorder configured to record the communication session.

In yet another aspect, the invention features a computer program product, tangibly embodied in a computer readable medium, for recording a communication session. The computer program product includes instructions being operable to cause data processing apparatus to receive a message that includes information about the communication session, to determine whether to record the communication session based on at least one criterion, and to mark the message to indicate that the communication session should be recorded if the at least one criterion is satisfied. In addition, the data processing apparatus is caused to transmit the message to a signaling entity configured to direct the message to a recorder if the at least one criterion is satisfied.

In other embodiments, any of the aspects above, or any apparatus, device or system or method, process or technique described herein, can include one or more of the following features.

In some embodiments, the signaling entity comprises an application server.

In some embodiments, the at least one criterion includes ingress trunk group identification or a number, an address, or a time associated with a communication session. The at least one criterion can reside on a component external to the edge device or in the edge device.

The marking of the message by the edge device to indicate recording can comprise adding a parameter to the message, changing a parameter value of the message, adding a header or a message body to the message or any combinations thereof.

In some embodiments, the edge device is further configured to duplicate a media stream associated with the communication session and forward the duplicated media stream to the recorder upon the recorder receiving the message from the signaling entity indicating the recording of the communication session.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a schematic diagram of an exemplary system for recording communication sessions.

FIG. 2 shows an exemplary edge device.

FIG. 3 shows an exemplary process for initiating recording of a communication session.

FIG. 4 shows an exemplary process for recording a communication session.

### DETAILED DESCRIPTION OF THE INVENTION

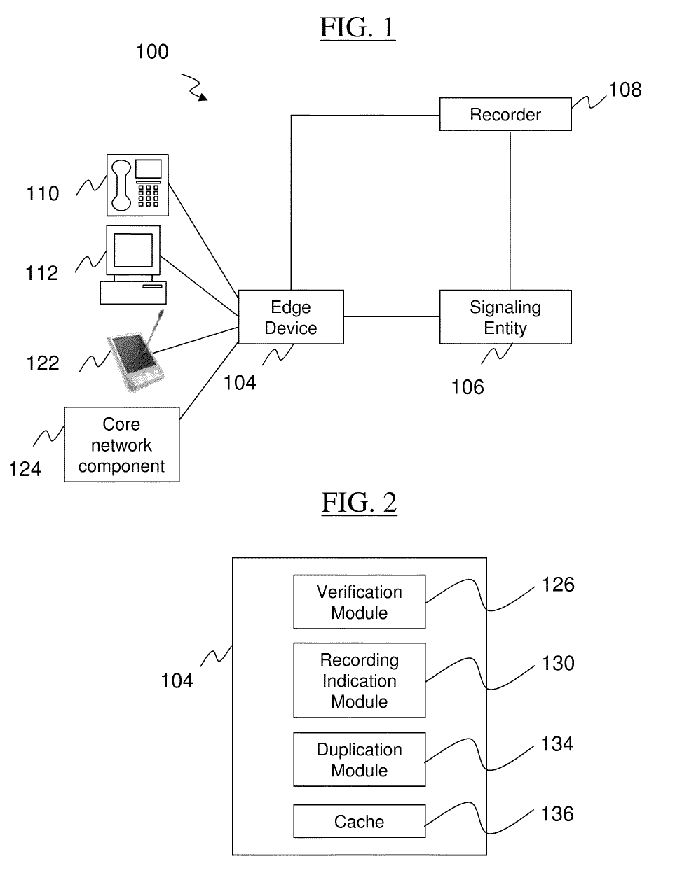

FIG. 1 shows a schematic diagram of an exemplary system 100 in which communication sessions can be recorded. As shown, system 100 includes one or more access devices and/or core network components coupled to an edge device 104, a signaling entity 106, and a recorder 108. An access device can be a telephone 110, a computer 112, a personal digital assistant (PDA) 122 or any other electronic device capable of interfacing with edge device 104. A core network component 124 can be a telephone switch, a softswitch, or a session border controller, for example. The edge device 104 can communicate with a signaling entity 106 and at least one recorder 108. In addition, signaling entity 106 can communicate with recorder 108.

Edge device 104 can be a router, a routing switch, an integrated access device (IAD), a multiplexer, a session border controller, or any device that can provide entry points or connections to network components and services. In general, edge device 104 operates by processing communication signals from access devices and/or core network components and transmitting them to other network components as needed, such as to signaling entity 106 or recorder 108. In an exemplary network environment, edge device 104 is controlled by a service provider or an enterprise, and access devices are installed at client premises or are portable. This setup allows edge device 104 to connect clients to enterprise or service provider networks. In certain embodiments, edge device 104 is a Network Border Switch™ manufactured by Sonus Networks, Inc., such as an NBS/SBX 5000. Even though edge device 104 is shown in system 100 as a separate entity, it can be distributed across other physical devices.

In some embodiments, edge device 104 receives from at least one access device or core network component information about a communication session. Such information can include metadata or other types of data describing the communication session, revealing, for example, identities of the participants in the communication session, dialog state and numbers or addresses indicating origin and destination of the communication session. In some embodiments, edge device 104 can obtain information about a communication session, such as its trunk group information, by identifying the communication channel from which the information is received. Such information can also include details about the session such as the type of media involved or the sampling rate. In some embodiments, information about a communication session is organized in a message form. An exemplary message format comprises one or more header fields that uniquely identify the communication session and a message body providing details about the session. An exemplary message format comprises an INVITE request in a SIP-based communication session. A communication session can be a video communication session, an audio session, an instant messaging session, a file transmission session or any other type of recordable communication session.

Based on the received information about a communication session, edge device 104 can determine whether to record the corresponding communication session by comparing the information with one or more predetermined conditions, criteria and policies. If edge device 104 decides to record the session, it can alter or augment the information about the communication session to indicate a recording need.

Signaling entity 106 can be an application server that provides communication routing and control functionalities. Signaling entity 106 can be a telephony switch, a signaling proxy, or a session border controller, for example. In operation, edge device 104 transmits information about a particular communication session to signaling entity 106. For those communication sessions with information that is altered or augmented to indicate recording, signaling entity 106 can forward the information to recorder 108 for recording of the corresponding communication session. In addition, signaling entity 106 need not transmit to recorder 108 information about those communication sessions that are not marked for recording. Signaling entity 106 can communicate with recorder 108 using standard communication control protocols, such as session initiation protocol (SIP), H.323, media gateway control protocol (MGCP), advanced intelligent network (AIN) or intelligent network application protocols (INAP). Signaling entity 106 can also communicate with recorder 108 using proprietary protocols or proprietary computer-telephony interface (CTI) protocols.

Recorder 108 is configured to communicate with edge device 104 upon receipt of information associated with a communication session indicative of a recording need. Recorder 108 can then establish a dialog with edge device 104 to receive at least one duplicated media stream associated with the communication session. During the same exchange, recorder 108 can also receive additional information about the communication session from edge device 104 to facilitate recording. Recorder 108 can communicate with edge device 104 using standard communication control protocols, such as SIP, H.323, MGCP, skinny client control protocol (SCCP), Integrated Services Digital Network (ISDN), ISDN User Part (ISUP), CTI protocols, or proprietary protocols.

FIG. 2 shows an exemplary edge device 104, including a verification module 126, a recording initiation module 130, a duplication module 134 and a cache 136.

To determine whether to record a communication session, edge device 104 can compare information about the session with one or more recording conditions, criteria and policies that can be stored in verification module 126. In certain embodiments, all or a portion of the conditions, criteria and policies can be stored in external network components that are accessible to edge device 104.

If edge device 104 makes the decision that a communication session should be recorded, it indicates such recording need by, for example, altering or augmenting existing information about the communication session. Such operation can be performed at recording indication module 130 of edge device 104.

In some embodiments, edge device 104 is further configured to duplicate one or more media streams associated with a communication session for the purpose of transmitting the duplicated media streams to recorder 108. Such duplication function can be performed at duplication module 134 of edge device 104. The duplicated media streams can include all media portions of the communication session or just a subset of the portions. In some instances, duplication is performed by another network component in system 100, and edge device 104 can invoke and request the other network component to transmit duplicated media streams to recorder 108.

In certain embodiments, edge device 104 includes one or more cache locations 136 for storing duplicated media streams and other pertinent information about a communication session. However, if duplicated media is sent in real-time to recorder 108, it may not be necessary to buffer the duplicated stream in cache 136. In addition, verification module 126 can reside in cache 136.

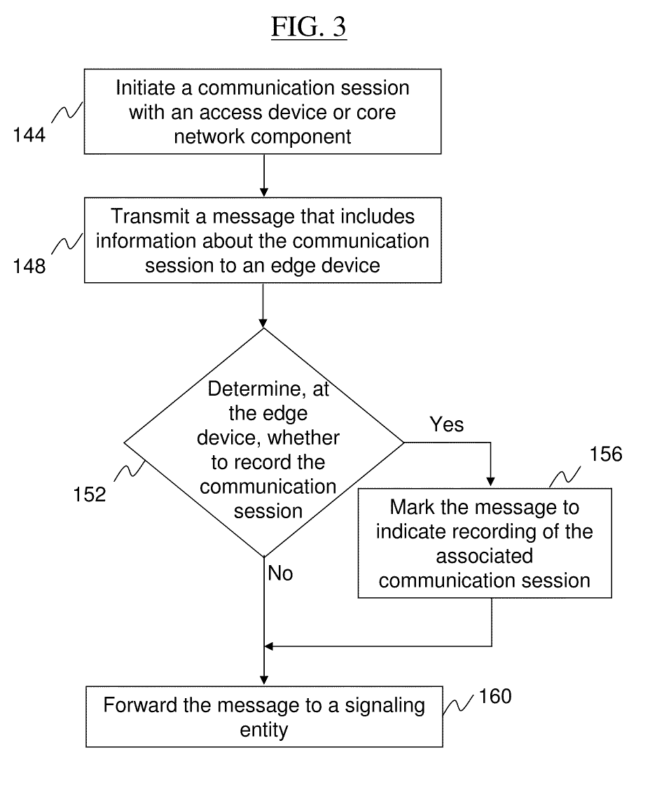

FIG. 3 shows a flow diagram illustrating an exemplary process for determining session recording at edge device 104. A communication session is established with at least one access device or core network component (step 144). Information about the communication session, captured in a message form, for example, is transmitted from the access device to edge device 104 for recording determination (step 148).

Edge device 104 determines whether to record the communication session using the received message about the session (step 152). In various embodiments, edge device 104 decides to record a communication session by comparing its ingress trunk group information with one or more predetermined recording policies, conditions or criteria stored in verification module 126 of edge device 104. For instance, by consulting a recording policy that specifies trunk groups for which media sessions need to be recorded, edge device 104 can subsequently decide to record all calls received on one trunk group but not calls received on another trunk group. In some embodiments, edge device 104 decides to record a communication session based on the identities of the participants in the communication session. For instance, edge device 104 can make recording decisions by consulting a recording policy that specifies the extensions of those devices from which calls should be monitored.

If edge device 104 determines that a communication session should be recorded, edge device 104 marks the message associated with the session to indicate the need to record the session (step 156). This marking can be accomplished by adding a parameter or tag to the body of the message, changing the value of an existing parameter of the message, adding a header to the message, changing the value of a parameter in an existing header of the message, adding a message body, performing a combination of these approaches or using any other means to mark the message to indicate recording.

Edge device 140 transmits the message associated with a media session to signaling entity 106 for further processing (step 160). In certain embodiments, the message is not marked for recording if edge device 104 decides at step 152 that one or more recording criteria have not been satisfied. In other embodiments, the message transmitted to signaling entity 106 is marked to indicate recording of the corresponding communication session if edge device 104 decides at step 152 that recording is necessary.

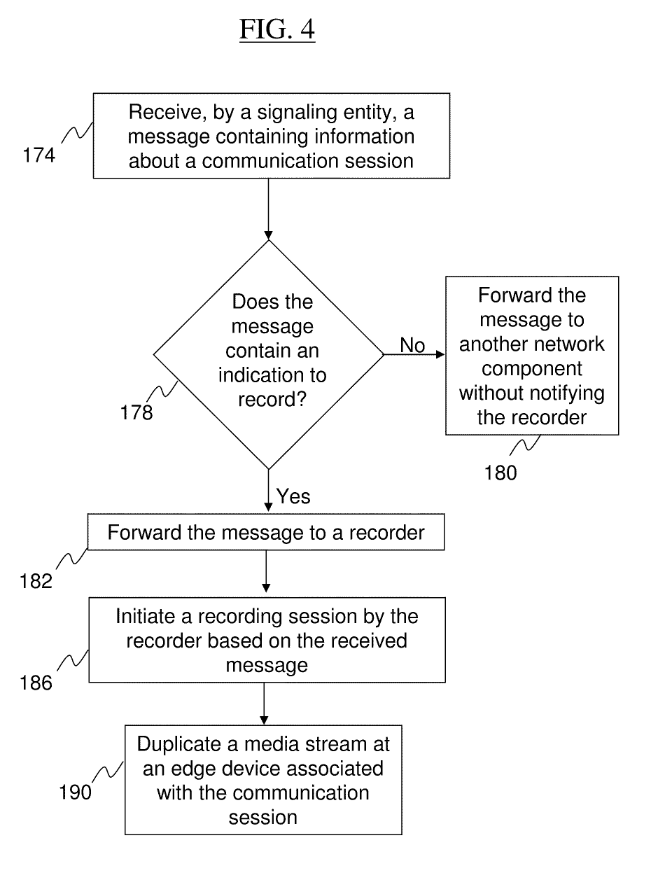

FIG. 4 illustrates a flow diagram showing an exemplary process for recording a communication session. Signaling entity 106 receives from edge device 104 a message that provides information about a corresponding communication session (step 174). In some embodiments, the message is marked by edge device 104 to indicate recording. In other embodiments, the message is not marked for recording.

Signaling entity 106 determines whether the received message is marked for recording (step 178). If such indication is detected, signaling entity 106 transmits the message to recorder 108, notifying recorder 108 to establish a recording session (step 182). If no recording indication is found, signaling entity 106 forwards the message to another network component, such as a hop signaling entity, without notifying recorder 108 (step 180).

Upon receiving a message from signaling entity 106 containing information indicating that a corresponding communication session should be recorded, recorder 108 initiates a media recording session with edge device 104 (step 186). In response, edge device 104 can replicate, in real-time, media associated with the communication session and transmit the replicated media streams to recorder 108 (step 190). Along with the replicated media streams, edge device 104 can also send to recorder 108 other information pertinent to the recording session, such as an indication of whether recording can commence immediately or can be paused until further notice.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for recording a communication session, comprising:
receiving a message that includes information about the communication session;
determining whether to record the communication session based on at least one criterion;
marking the message to indicate that the communication session should be recorded if the at least one criterion is satisfied; and
transmitting the message to a signaling entity configured to direct the message to a recorder if the at least one criterion is satisfied.

2. The system of claim 1 wherein the signaling entity comprises an application server.

3. The method of claim 1 wherein an edge device receives the message, determines whether to record the communication session, marks the message and transmits the message to the signaling entity.

4. The method of claim 1 wherein the at least one criterion comprises one of ingress trunk group identification, a number or an address associated with a party of the communication session.

5. The method of claim 1 wherein the marking comprises adding a parameter to the message.

6. The method of claim 1 wherein the marking comprises changing a parameter value of the message.

7. The method of claim 1 wherein the marking comprises adding a header or a message body to the message.

8. The method of claim 1 further comprising:
duplicating a media stream associated with the communication session; and
forwarding the duplicated media stream to the recorder upon the recorder initiating a recording session based on the message.

9. A system for recording a communication session, comprising:
an edge device configured to:
receive a message that includes information about the communication session;
determine whether to record the communication session based on at least one criterion; and
mark the message to indicate that the communication session should be recorded if the at least one criterion is satisfied; and
a signaling entity configured to (i) receive the message from the edge device and (ii) if the at least one criterion is satisfied, direct the message to a recorder configured to record the communication session.

10. The system of claim 9 wherein the signaling entity comprises an application server.

11. The system of claim 9 wherein the recorder is further configured to initiate a recording session based on the message and receive from the edge device a duplicated media stream associated with the communication session.

12. The system of claim 9 wherein the at least one criterion resides on a component external to the edge device.

13. The system of claim 9 wherein the at least one criterion comprises ingress trunk group identification, a number or an address associated with a party of the communication session.

14. The system of claim 9 wherein the at least one criterion comprise a number, an address, or a time associated with the communication session.

15. The system of claim 9 wherein the edge device marks the message by adding a parameter to the message.

16. The system of claim 9 wherein the edge device marks the message by changing a parameter value of the message.

17. The system of claim 9 wherein the edge device marks the message by adding a header or a message body to the message.

18. A computer program product, tangibly embodied in a computer readable medium, for recording a communication session, the computer program product including instructions being operable to cause data processing apparatus to:
receive a message that includes information about the communication session;
determine whether to record the communication session based on at least one criterion;
mark the message to indicate that the communication session should be recorded if the at least one criterion is satisfied; and
transmit the message to a signaling entity configured to direct the message to a recorder if the at least one criterion is satisfied.
